(19) United States
(12) Patent Application Publication
(10) Pub. No.: US 2010/0058587 A1
(43) Pub. Date: Mar. 11, 2010

(54) SPACER ARRANGING METHOD

(75) Inventors: Takumi NAMEKAWA, Chigasaki-shi (JP); Kouji Hane, Chigasaki-shi (JP); Matsudai Masasuke, Chigasaki-shi (JP); Sunaga Yoshio, Chigasaki-shi (JP); Yuyama Junpei, Chigasaki-shi (JP); Suwa Hidenori, Chigasaki-shi (JP)

Correspondence Address: KRATZ, QUINTOS & HANSON, LLP, 1420 K Street, N.W., Suite 400, WASHINGTON, DC, 20005, US

(73) Assignee: ULVAC, INC., Chigasaki-shi (JP)

(21) Appl. No.: 12/621,864

(22) Filed: Nov. 19, 2009

Related U.S. Application Data
(63) Continuation of application No. PCT/JP08/59055, filed on May 16, 2008.

(30) Foreign Application Priority Data
May 22, 2007 (JP) 2007-135431

(51) Int. Cl. B23P 17/00

(52) U.S. Cl. 29/890.1

(57) ABSTRACT

A technique for arranging spacers with no streaks is provided. On columns of a light-shielding zone of a coating object, ejection positions are set and stored as temporary ejection positions in a memory unit. Random numbers of positive or negative real values are generated by a random number generating function. Every time a positive or negative random number is generated, one temporary ejection position and one random number are correlated to each other and stored as a random number coefficient R. Assuming that the coordinate of the temporary ejection position is expressed by (X, Y), a corrected ejection position (X+L×R, Y) is determined by multiplying the stored random number coefficient R with the interval L between the adjacent temporary ejection positions in the same column, and adding the value of the coordinate X to the multiplied value. The determined corrected ejection position is stored.

This application is a continuation of International Application No. PCT/JP2008/059055, filed May 16, 2008, which claims priority from Japan Patent Application No. 2007-135431, filed May 22, 2007. The contents of the prior applications are herein incorporated by reference in their entireties.

### BACKGROUND

The present invention generally relates to a spacer arranging method.

Disposed between a front panel and a rear panel of a liquid crystal display device are spacers for forming a gap between the panels in which the liquid crystals are sealed.

In order to arrange such spacers, ink jet type printers have been recently used. Generally, an ejection head having a number of nozzle holes arranged in a line is moved relative to a substrate while a voltage is applied to a piezoelectric element disposed inside the ejection head. This results in an ejection liquid containing the spacers being ejected through the respective nozzle holes to land upon ejection positions arranged in a matrix fashion on the substrate. The ejection liquid is then dried. Thereby, spacer groups composed of a plurality of spacers per one ejection position are arranged. The spacers are arranged at regular positions within the panel planes so that no warping occurs between the panels.

In FIG. 7, a reference numeral 110 denotes a liquid crystal display panel in which light transmitting portions 112 are arranged in a lattice fashion among a black matrix 111, and spacer groups 115 are positioned in a matrix fashion on the black matrix 111.

However, since there are variations in the formation accuracy of the nozzle holes and the characteristics of the piezoelectric element, the ejected liquid does not land exactly on the set ejection position, so that a deviation between the set ejection position and the position on which the ejected liquid actually lands occurs.

The actual landing positions often deviate from the set ejection positions arranged in the matrix fashion. When the error is caused by the nozzle hole, a series of landing positions having the deviations results, so that the spacers groups arranged on the landing positions having the deviations are observed as a streak. This results in a display device that is perceived of as an inferior product.

Similar problems are mentioned in JP2004-37855 and JP 2004-109856.

### SUMMARY OF THE INVENTION

The present invention, which has been made to solve the above problem, provides a spacer arranging technique which does not result in streaks.

While one cause for the formation of the streaks is the deviation of the actual ejection positions of the ejected liquid from the set matrix ejection positions, the inventors of the present invention discovered that the cause for the formation of the streaks could rather be thought of as the very effort to regularly arrange the ejection positions in the first place.

Since the formation of the streaks results because the spacer groups which are set to be arranged at regular positions deviate from the position determined by a rule for a large majority of the spacer groups, the ejection positions may be prevented from being arranged regularly on a coating object to eliminate the streaks. In such a case, the deviation of the actual landing positions from the set ejection positions determined by the rule does not have to be eliminated to remove the streaks.

The present invention has been made from the above explained point of view, and is directed to a spacer arranging method for arranging spacers at a plurality of positions on light-shielding zones by making an ejection head having a plurality of nozzle holes move relative to a coating object, in order to eject an ejection liquid containing the spacers from the nozzle holes to make the ejection liquid land on the light-shielding zones which are arranged at positions in a lattice fashion on the coating object, wherein random numbers are generated so that ejection positions are set on the light-shielding zone according to the random numbers, in order to eject the ejection liquid onto the ejection positions.

Also, the present invention is directed to the spacer arranging method, wherein temporary ejection positions are set on the light-shielding zone, and displacement amounts are calculated according to the random numbers with respect to the respective ejection holes, in order to set the ejection positions at positions on the light-shielding zones spaced away from the temporary ejection positions by the calculated displacement amounts.

Further, the present invention is directed to the spacer arranging method, wherein intervals among the temporary ejection positions arrayed in a straight line are set to be equal.

The present invention is constructed as explained above in which the light-shielding zone is arranged in a lattice fashion on the substrate. Assuming that, among the light-shielding zones arranged in the lattice fashion, one group which consists of the ones parallel to each other are columns, and that the other group consists of the ones orthogonal to the columns are rows, the present invention is directed to the spacer arranging method in which the positions of the spacers arranged on the columns or the rows are determined according to the random number coefficients, and the spacer groups arranged at the regular positions may be combined with the spacer groups arranged according to the random coefficients.

According to the present invention, no streaks are observed on the coating object on which the spacers are arranged.

### BRIEF DESCRIPTION OF THE DRAWINGS

FIG. 1 is a side view for illustrating an embodiment of an ejection device to be used in the present invention.

FIG. 2 is a plan view for illustrating an embodiment of an ejection device to be used in the present invention.

FIG. 3 is a plan view for illustrating an embodiment of nozzle holes provided in the ejection head.

FIG. 4 is a plan view for illustrating an embodiment of a surface of an unprocessed coating object.

FIG. 5 is a plan view for illustrating a surface of the coating object of an embodiment of the present invention in a state in which the spacers are arranged according to the random number coefficients.

FIG. 6 is a plan view for illustrating a surface of the coating object of an embodiment of the present invention, on which spacers positioned according to the random number coefficients and the spacers regularly positioned are arranged in combination.

FIG. 7 is a plan view for illustrating a surface of a coating object on which streaks are observed.

### DETAILED DESCRIPTION OF THE INVENTION

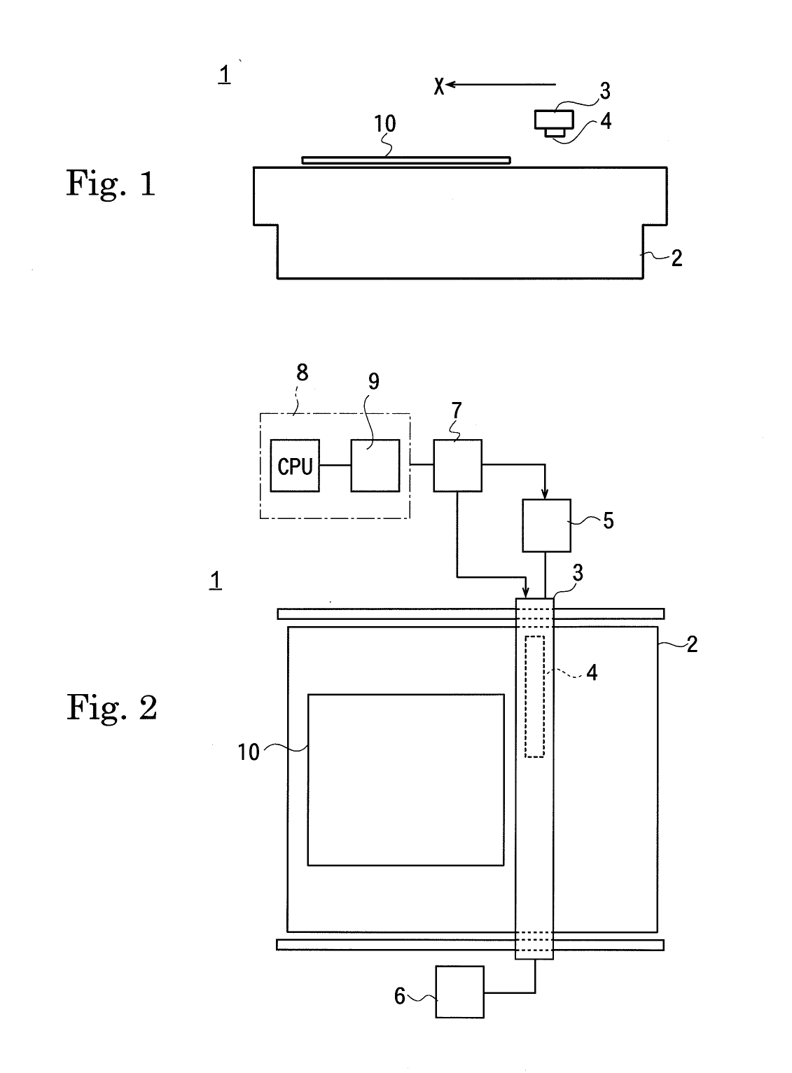

FIG. 1 is a side view of an ejection device 1 which can be used in the present invention, and FIG. 2 is a plan view thereof.

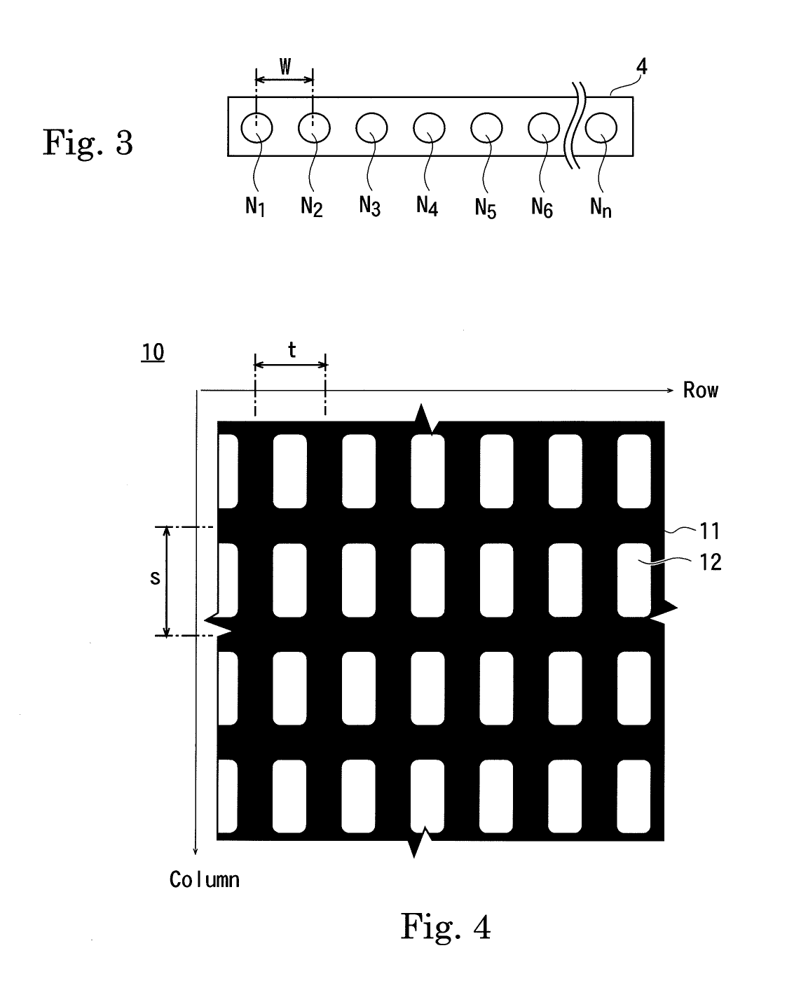

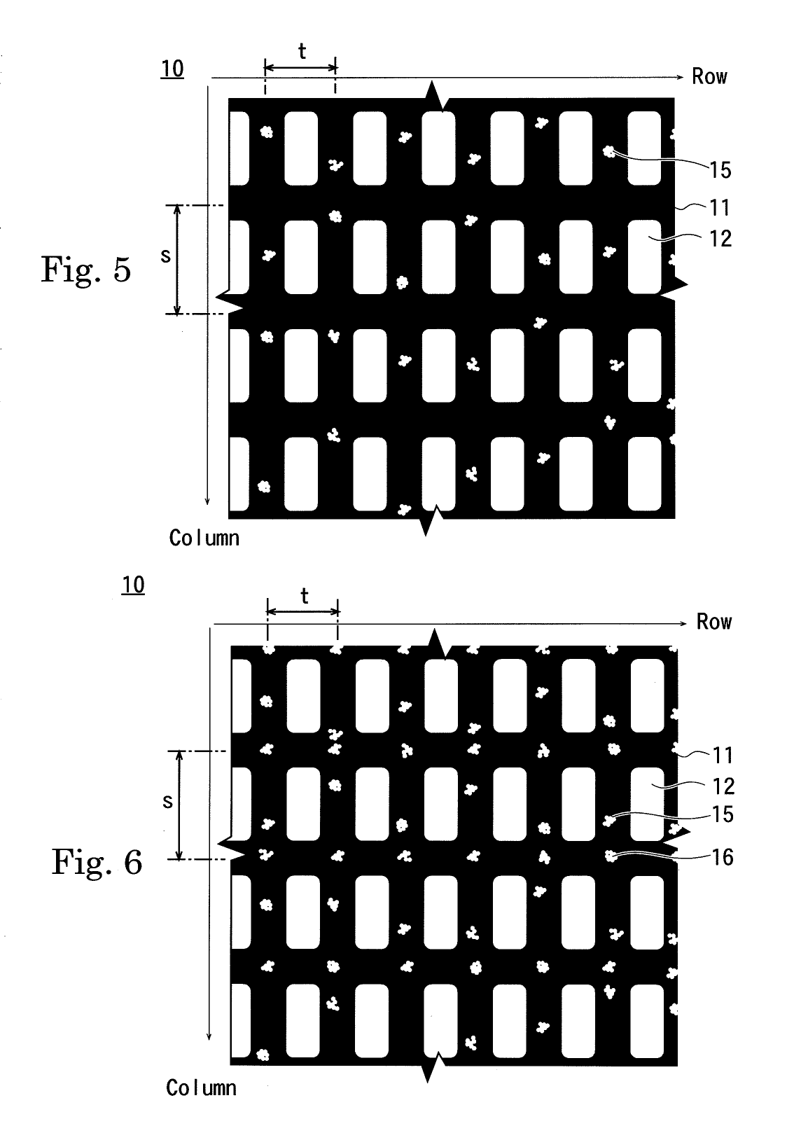

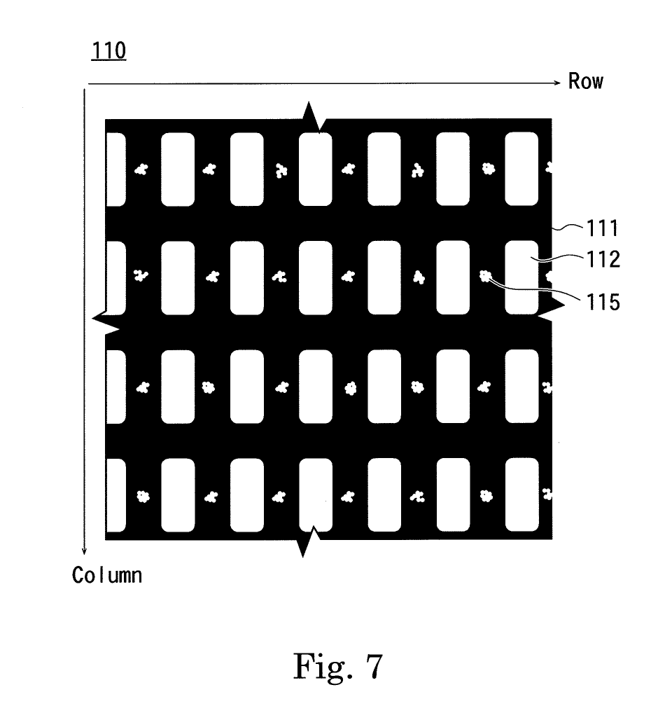

This ejection device 1 has a table 2. An ejection head 4 having a plurality of nozzle heads N₁ to Nₙ as shown in FIG. 3 is arranged at a shaft 3 arranged above the table 2. The ejection head 4 is connected to an ejection liquid feeding device 5 and a controller 7. An ejection liquid containing spacers is placed in the ejection liquid feeding device 5. When the ejection liquid is fed into the ejection head 4 from the ejection liquid feeding device 5, desired amounts of the ejection liquid are ejected through the respective nozzle holes N₁ to Nₙ by means of the controller 7.

The shaft 3 is configured such that the shaft may move reciprocatingly relative to the table 2, in a direction vertical to the direction in which the shaft 3 extends, and linearly within a horizontal plane. The ejection head 4 is configured to move reciprocatingly along the shaft 3 within a horizontal plane.

When the shaft 3 linearly moves relative to the coating object 10 placed on the table 2 in a state where the ejection head 4 is at rest relative to the shaft 3, the ejection head 4 linearly moves relative to the coating object 10.

In this embodiment, the coating object 10 is at rest. However, while the shaft 3 is at rest, the coating object 10 may move linearly relative to the shaft 3, or both may move in order to make linear movement relative to each other.

FIG. 4 is a plan view of a coating object 10 on which the spacers are to be arranged.

The coating object 10 has a light-shielding zone 11 through which light does not pass and light transmitting portions 12 through which light passes.

The light-shielding zones 11 are composed of band-like thin films having a constant width, which are arranged in a lattice fashion on the surface of the coating object 10, and areas surrounded by the light-shielding zones 11 are the light transmitting portions 12.

Assuming that, one group which consists of the light-shielding zones 11 parallel to each other among the light-shielding zones 11 in the lattice fashion are columns, and that the others vertical to the columns are rows, the columns of the light-shielding zones 11 are formed at a constant interval t, while the adjacent rows are also formed at a constant interval s.

Further, the nozzle holes N₁ to Nₙ are arranged at a constant interval w in a line. The interval w among the nozzle holes N₁ to Nₙ is set to be larger than the interval t among the columns. The ejection head 4 is configured to be rotatable within a horizontal plane.

The coating object 10 is arranged on the table 2 such that either the columns or the rows of the light-shielding zones 11 are parallel to the moving directions in which the coating object 10 and the ejection head 4 move relative to each other.

Assuming that the columns are arranged to be parallel to the moving directions in this embodiment, when the ejection head 4 is first turned such that the ejection head 4 is directed to a direction in which an angle θ formed by a line segment connecting the centers of the nozzle holes N₁ to Nₙ and the direction in which the columns of the light-shielding zones 11 extends satisfies t=w×cos θ, the respective nozzle holes N₁ to Nₙ can be arranged at the positions above the columns of the light-shielding zones 11.

When the ejection head 4 and the coating object 10 are moved relative to each other by moving the shaft 3, the ejection liquid can be ejected onto the desired positions on the columns.

A computer 8 is connected to a controller unit 7, and ejection positions on which the ejection liquid is to be applied on the columns through the respective nozzles N₁ to Nₙ can be preliminarily stored in a memory unit 9 of the computer 8.

A method for storing the ejection positions, produced according to the random numbers is now explained.

A program of a random number generating function is stored in the memory unit 9 of the computer 8. In this embodiment, assuming that the ejection positions are set on the columns of the light-shielding zones 11 and at positions arranged in a mutual matrix fashion, and that the set values are stored as temporary ejection positions in the memory unit 9, the intervals among the temporary ejection positions in one column are set to be equal. The intervals among the temporary ejection positions in one line may also be set to be equal. First, real-valued positive or negative random numbers are generated by means of the random number generating function; every time they are generated, one temporary ejection position and one random number are correlated and stored as a random number coefficient R. For example, the temporary ejection positions may be numbered. And then, they are stored after they are correlated to the order of the generation of the random numbers.

Assuming one coordinate in the direction in which the columns extend is X, the other coordinate in the direction in which the rows extend is Y, and the coordinate of the temporary ejection position is expressed by (X, Y), a corrected ejection position (X+L×R, Y) is determined by multiplying the stored random number coefficient R with the interval L between the adjacent temporary ejection positions in the same column, and adding the value of the coordinate X to the multiplied value. Then, the resulting value is stored. L×R is a displacement amount given due to the generation of the random number.

The corrected ejection position (X+L×R, Y) is shifted to a position which is displaced to a side of the origin of the Y coordinate by |L×R|, or to a position which is displaced to the opposite side of the origin by |L×R|, depending upon the sign of the random number coefficient R, relative to the temporary discharge position (X, Y).

The displacing area of the temporary ejection position (X, Y) is in a range of ±|L×R| around the temporary ejection position (X, Y). In order to prevent the displacing areas of the adjacent temporary ejection positions (X+L, Y) and (X−L, Y) from overlapping, the random number coefficients R have only to be generated in a range of −0.5<R<0.5.

When the corrected ejection positions are determined for the respective temporary ejection positions, the corrected ejection positions are stored, the ejection head 4 and the coating object 10 are moved relative to each other, and the ejection liquid is ejected in order to let the ejection liquid land on the corrected ejection positions through the respective nozzle holes N₁ to Nₙ. If the number of columns of the ejection positions on the coating object 10 is greater than the number of the nozzle holes N₁ to Nₙ, the ejection head 4 is moved along the shaft 3, the nozzle holes N₁ to Nₙ are positioned above columns onto which the ejection liquid has not ejected, and the ejection liquid is ejected onto the stored corrected ejection positions in the same manner as explained above.

In FIG. 6, reference numeral 15 shows a spacer group composed of a plurality of spacers arranged according to the random number coefficient R.

As explained above, since the ejection positions are set at the random positions on the coating object 10 according to the present invention, even if the ink does not land on the set ejection positions, and even if there are spacers groups which deviate from the set ejection positions, the displacement amounts caused by those deviations are absorbed by the displacement amounts as a result of the random number coefficients. Consequently, no streaks are observed.

In the above, while the case in which the corrected ejection positions are determined by means of shifting the stored temporary ejection positions has been explained, the present invention is not limited thereto. The coordinates of the corrected ejection positions may be produced directly based on the random numbers.

For example, in order that a coordinate x, which is in a direction of extension of the columns, may set n corrected ejection positions within a range of 0<x<A of a column, n random number values r which have a value within a range of 0<r<A are generated for producing a corrected ejection position (r, Y). Different random numbers are generated for the respective columns, and the corrected ejection positions are computed and stored.

In addition, although all of the ejection positions are set according to the random numbers in the above explanation, the ejection positions set at the regular positions and the ejection positions set according to the random numbers may be mixed.

For example, as explained above, the ejection positions can be set on the columns of the light-shielding zones according to the random numbers, and, separately from that, the other ejection positions can be set at the regular positions at which the rows and the columns intersect.

In FIG. 6, reference numeral 15 shows the spacer groups which are arranged according to the random number coefficient R, and reference numeral 16 of the same figure shows the spacer groups which are arranged at the regular positions at which the row and the column intersect.

While, in the above embodiment, the number of the ejection positions in one column is set to be the same for each column, the number may vary for other embodiments of the present invention. Also, the ejection positions may be set at random positions on the rows rather than on the columns. Further, the ejection positions may be arranged at positions of both of the rows and the columns, other than at the intersections of the rows and columns.

What is claimed is:

1. A method for arranging spacers at a plurality of positions on a light-shielding zone by making an ejection head having a plurality of nozzle holes move relative to a coating object in order to eject an ejection liquid containing the spacers from the nozzle holes to make the ejection liquid land on the light-shielding zone at positions arranged in a lattice fashion on the coating object, the method comprising:
generating random numbers and setting ejection positions on a light-shielding zone using the random numbers in order to eject the ejection liquid onto the ejection positions.

2. The method of claim 1, wherein temporary ejection positions are set on the light-shielding zone, thereby displacement amounts are calculated using the random numbers with respect to the respective ejection holes in order to set the ejection positions at positions on the light-shielding zones spaced away from the temporary ejection positions by the displacement amounts.

3. The method of claim 2, wherein intervals among the temporary ejection positions arrayed in a straight line are set to be equal.
